(19) United States
(12) Patent Application Publication
(10) Pub. No.: US 2016/0171225 A1
(43) Pub. Date: Jun. 16, 2016

(54) DETERMINING PRIVACY GRANULARITY

(71) Applicant: International Business Machines Corporation, Armonk, NY (US)

(72) Inventors: Roee Hay, Haifa (IL); Omer Tripp, Har Adar (IL)

(21) Appl. No.: 14/568,684

(22) Filed: Dec. 12, 2014

(51) Int. Cl. G06F 21/60; G06F 21/64; G06F 21/56

(52) U.S. Cl. CPC G06F 21/606; G06F 21/563; G06F 21/64

(57) ABSTRACT

Techniques for determining privacy granularity in a data flow are described herein. The techniques may include identifying a data flow source statement within a computer program and identifying a feature read at the source statement. The feature includes private data of a private data category. The techniques include identifying a sink of the data flow and determining a value associated with the feature flowing into the sink. The value indicates a degree of granularity of the private data flowing into the sink.

### BACKGROUND

The present invention relates generally to security analysis. More specifically, the techniques described herein include monitoring for potential leaks of private information.

### SUMMARY

In one embodiment, a method for determining privacy granularity is described herein. The method includes identifying a data flow source statement within a computer program. A feature read at the source statement is identified. The feature includes private data of a private data category. A sink of the data flow is also identified. A value associated with the feature flowing into the sink is determined. The value indicates a degree of granularity of the private data flowing into the sink.

System and computer program products relating to the above-summarized methods are also described and claimed herein.

### BRIEF DESCRIPTION OF DRAWINGS

FIG. 1 is a block diagram of a computing system configured to determine a degree of granularity of private data flowing to a sink, according to embodiments of the present invention;

FIG. 2 is a block diagram of further aspects of a system for determining a degree of granularity of private data flowing into the sink, according to embodiments of the present invention;

FIG. 3 is pseudo code illustrating monitoring a data flow to determine granularity of private data flowing into a sink, according to embodiments of the present invention;

FIG. 4 is a flow chart illustrating a method of determining granularity of private data in a data flow, according to embodiments of the present invention; and

FIG. 5 is a block diagram depicting an example of a tangible, non-transitory computer-readable medium that can be used to compare source and sink values, according to embodiments of the present invention.

### DETAILED DESCRIPTION

The subject matter disclosed herein relates to techniques for determining granularity of private data flowing from a source statement to a sink statement in a data flow. Preventing private data from being released is a growing concern. For example, in mobile applications, demands to access private information may be frequent. Examples of private information may include a unique identifier of a computing device, such as an International Mobile Equipment Identity (IMEI) number, a phone number, or social affiliations of a user of the device, a location of a user, audio and video data, and the like.

While private information often services a core functionality of a given application, it may also serve other purposes such as advertising, analytics, cross-application profiling and the like. A user may be unable to distinguish legitimate usage of their private information from illegitimate scenarios and may even be unaware of sending private information, such as sending an IMEI number to a remote advertising website to create a persistent profile of the user. Existing platforms provide limited support for tracking the potential release of private data. In some cases, a platform may track data flow in the form of taint analysis and provide a Boolean operation wherein if the data flow contains information in a broad category, such as data indicating a location, the data may be suppressed or flagged. However, in some cases, a location such as a country may not be considered important private data even though it is categorized as a location. In other words, there is a lack of granularity provided in determining which data is potentially private data that should or should not be released.

The techniques described herein include determining a granularity of data to be released. More specifically, the techniques described herein read a source statement to identify whether data from the source statement includes data that is potentially private. (Data that is potentially private may be referred to herein as a “feature” read at the source statement). A feature may be associated with a category of private data. For example, a feature may be a phone number associated with a user identification category of private data. In some cases, only a prefix of the phone number will ultimately be released depending on the value of the feature at a sink statement. Therefore, the techniques described herein include identification of a sink statement of the data flow, and determining the value associated with the feature flowing into the sink. The value may indicate a degree of granularity of the private data flowing into the sink. For example, while the feature indicates that a phone number of a user of a device may be referenced, only a portion of the phone number may be provided to the sink. In other words, the techniques described herein implement a method and system wherein granularity of potentially private data is determined before being released at a sink statement.

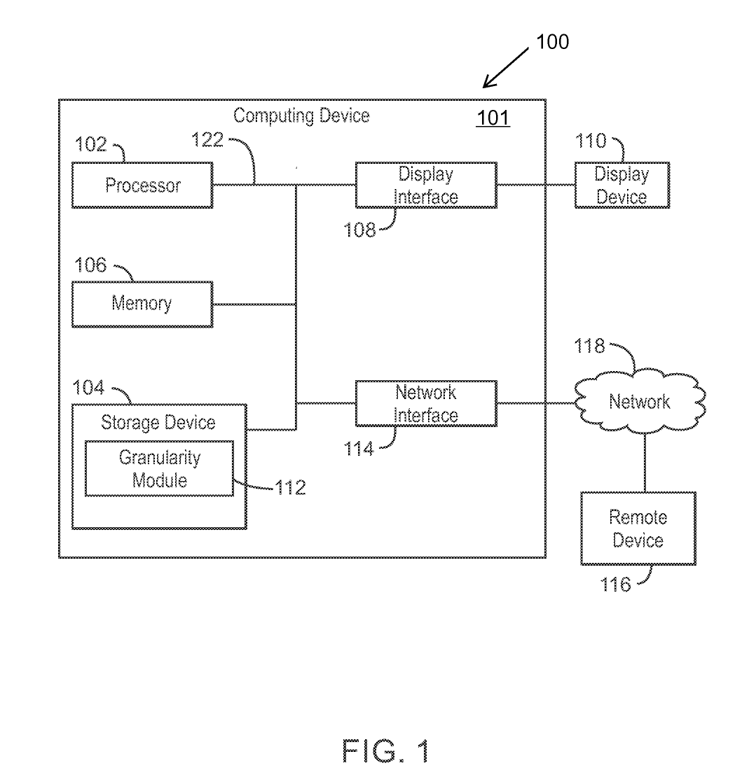

FIG. 1 is a block diagram of a computing system configured to determine a degree of granularity of private data flowing to a sink. The computing system 100 may include a computing device 101 having a processor 102, a storage device 104 comprising a non-transitory computer-readable medium, a memory device 106, a display interface 108 communicatively coupled to a display device 110. The computing device 101 may include a network interface 114 communicatively coupled to a remote device 116 via a network 118. The storage device 104 may include a granularity module 112 configured to determine a granularity value of potentially private data before flowing into a sink statement of a data flow. In embodiments, the granularity module 112 may be used by a computing device 101 to prevent private data from being released to the remote device 116 via the network 118. In some embodiments, the display interface 108 may enable a user of the computing system 101 to set thresholds for granularity levels that enable data to be released or not released, based on user preferences. The display device 110 may be an external component to the computing device 101, an integrated component of the computing device 101, or any combination thereof.

The granularity module 112 may be logic, at least partially comprising hardware logic. In embodiments, the granularity module 112 may be implemented as instructions executable by a processing device, such as the processor 102. The instructions may direct the processor 102 to identify a data flow source statement within a computer program and identify a feature read at the source statement. The feature may include private data of a private data category. For example, the private data may be a city indication in a location category. The instructions may also direct the processor 102 to identify a sink statement of the data flow and determine a value associated with the feature flowing into the sink. The value indicates a degree of granularity of the private data flowing into the sink.

The processor 102 may be a main processor that is adapted to execute the stored instructions. The processor 102 may be a single core processor, a multi-core processor, a computing cluster, or any number of other configurations. The memory unit 106 can include random access memory, read only memory, flash memory, or any other suitable memory systems. The main processor 102 may be connected through a system bus 122 to components including the memory 106, the storage device 104, and the display interface 108.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

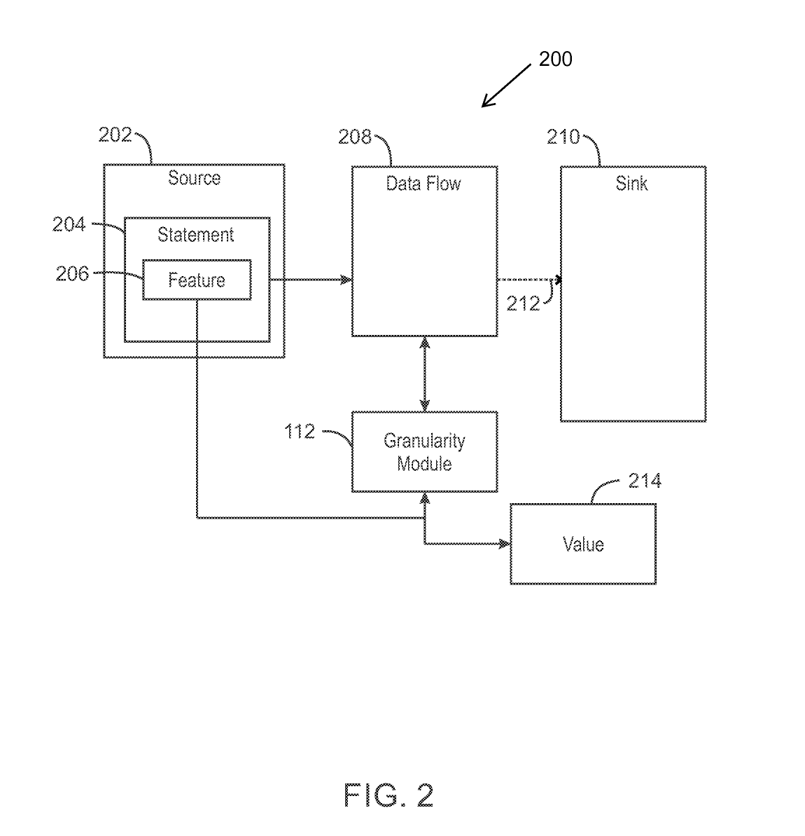

FIG. 2 is a block diagram of a system 200 for determining a degree of granularity of private data flowing into the sink. As illustrated in FIG. 2, a computing program may be utilized to compare data values at a source to data values occurring prior to being provided to a sink. The computing program may include a source 202 having a statement 204 configured to read a feature 206. For example, the source statement 204 may read a device identification (ID) number of a mobile device. In this scenario, the device ID is private data that has an identification feature.

Features 206 may be derived from a runtime state of a program, for example, or a feature 206 may be derived during compile-time or load-time code instrumentation, or by inserting callbacks into the program via debug breakpoints.

The granularity module 112 may monitor the data flow 208 immediately prior to being provided to the sink 210, as indicated by the dashed arrow 212. In some cases, data flow 208 may be monitored by implementing taint analysis in any data flow stemming from the statement 204.

The granularity module 112 may determine a value 214 associated with the feature 206. The value 214 may be determined by using a sliding window and one or more string metrics utilized to compare the feature 206 with the data flow 208.

In the example above, a device ID may include 16 characters. However, only 3 of the 16 characters may appear in the data flow 208 that is about to be released via the sink 210. Therefore, in this scenario, the value 214 is low in comparison to a scenario wherein the data flow contained all 16 characters of the device ID.

As discussed above, the value 214 represents the granularity of private data that is about to be provided to the sink statement 208. The value 214 may be derived using string metrics to compare the feature 206 to the data flow 208. Examples of string metrics may include a Hamming string metric, a Levenshtein string metric, and the like. However, other types of factors may be considered, including a Bayesian probability that the value flowing into the sink is a privacy threat based on a threshold. For example, in some cases, the value 214 may be an aggregate value based on multiple features and multiple associated values. For example, if the data flow 208 providing data to the sink 210 is to provide location data including a country, as well as a last name of a user, then an aggregate value may be lower than an aggregate value wherein the data includes a last name, and a street address. In any case, aggregate values and specific computations of the aggregate values may be implemented by a user, manufacturer, or designer of the system.

Another example of a value determination factor may include characteristics of a sink to which private information may be released. For example, the sink 210 may include file access modes that are public, rather than private. Therefore, in this scenario, the file access modes of the sink 210 that are public may raise the value 214 to generate an alarm that may be otherwise negligible. Another example of a value determination factor may include a history of data flows having the same feature that have flowed into the sink. For example, the sink 210 may be associated with multiple previous application programming protocol (API) invocations wherein declassifications for privacy data were invoked.

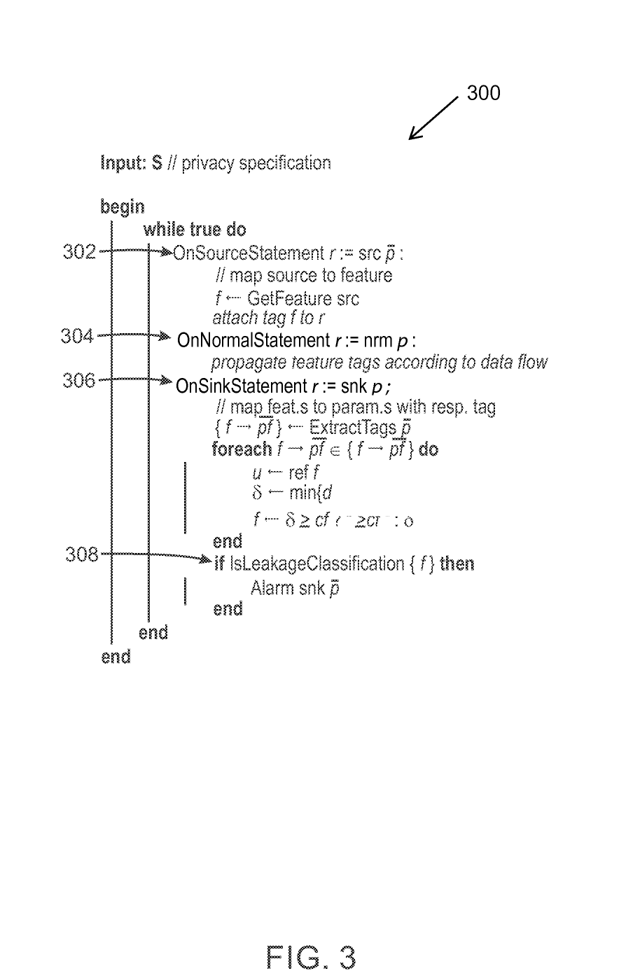

FIG. 3 is a diagram illustrating an example of pseudo code that may be implemented to determine granularity of private data flowing into a sink. The “On Source Statement” 302 is the event that is triggered when a source statement is run. The On Source Statement 302 may derive one or more features. For example, if the source includes a telephone number, then source may be classified in a feature called “user ID.” Following classifying the relevant feature, a taint tracking is started.

The “On Normal Statement” 304 indicated that the taint is propagated through the data flow of the program. The “On Sink Statement” 306 indicates that the data has reached the sink, or is just about to reach the sink. All of the data reaching the sink via the taint analysis monitoring are determined, and comparisons to the original feature at the source are determined. An “Is Leakage Classification” 308 may be based on the comparison of taint data and source features, or an aggregate of taint data and source feature comparisons.

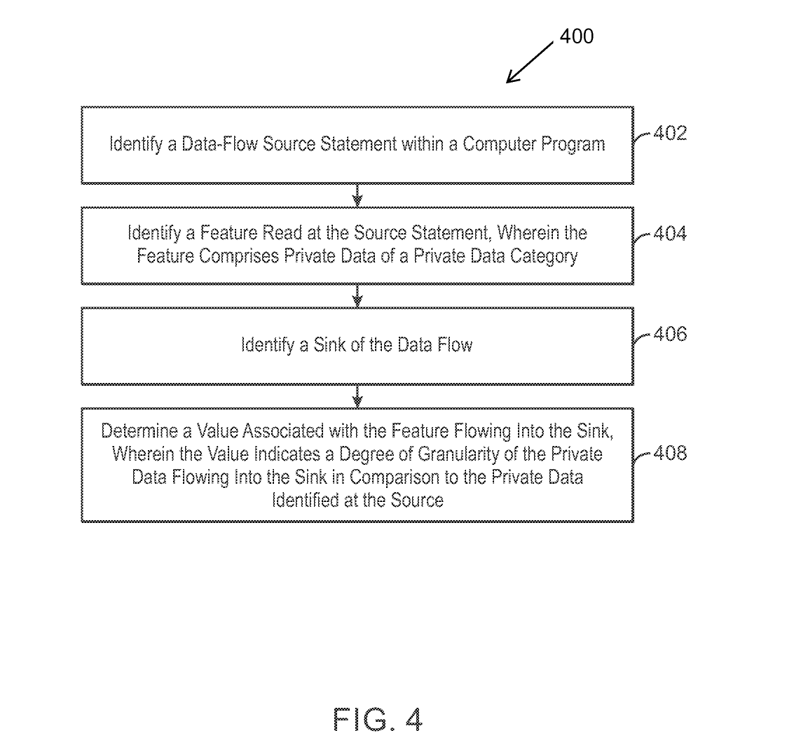

FIG. 4 is a block diagram illustrating a method of determining granularity of private data in a data flow. The method 400 includes identifying a data flow source statement within a computer program, as indicated at block 402. At 404, a feature read at the source statement is identified. The feature includes private data of a private data category. At block 406, a sink of the data flow is identified. At block 408, a value is determined, wherein the value is associated with the feature, and wherein the value is flowing into the sink. The value is configured to indicate a degree of granularity of the private data flowing into the sink.

Other components may be included in the method 400. For example, the method 400 may further include issuing a security warning if a privacy threat exists. The value determined at block 408 is determined based on a Bayesian probability that the value flowing into the sink is a privacy threat. In some cases, this may be determined based on whether the probability meets a predetermined threshold.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++, JavaScript, objective C and C#, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

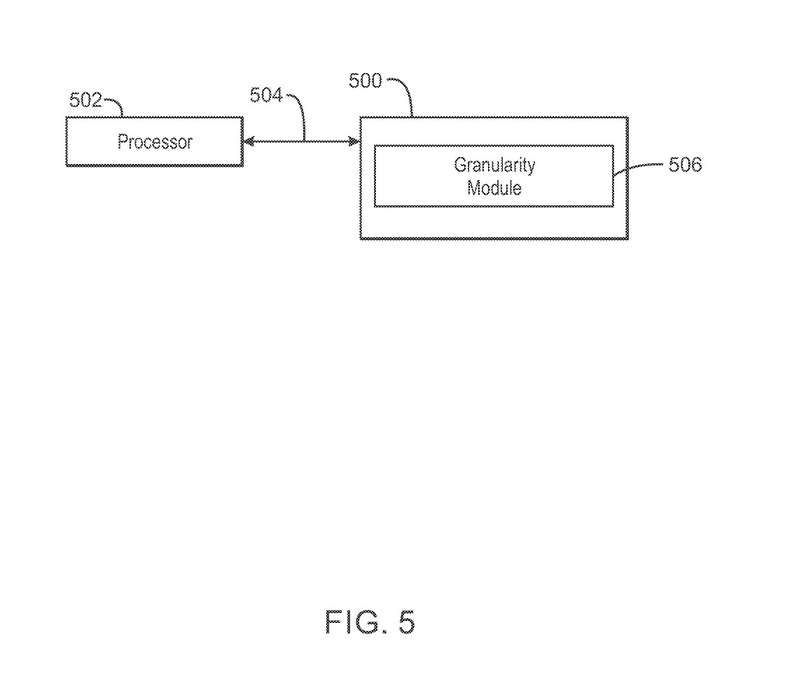

FIG. 5 is a block diagram depicting an example of a tangible, non-transitory computer-readable medium that can be used to compare source and sink values. The tangible, non-transitory, computer-readable medium 500 may be accessed by a processor 502 over a computer bus 504. Furthermore, the tangible, non-transitory, computer-readable medium 500 may include computer-executable instructions to direct the processor 502 to perform the steps of the current method.

The various software components discussed herein may be stored on the tangible, non-transitory, computer-readable medium 500, as indicated in FIG. 5. For example, a granularity module 506 may be configured to identify a data-flow source statement within a computer program and identify a feature read at the source statement, wherein the feature comprises private data of a private data category. The granularity module 506 may further be configured to identify a sink statement of the data flow, and determine a value associated with the feature flowing into the sink, wherein the value indicates a degree of granularity of the private data flowing into the sink.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method determining privacy granularity, comprising:
identifying a data flow source statement within a computer program;
identifying a feature read at the source statement, wherein the feature comprises private data of a private data category;
identifying a sink statement of the data flow;
determining a value associated with the feature flowing into the sink, wherein the value indicates a degree of granularity of the private data flowing into the sink in comparison to the private data identified at the source.

2. The method of claim 1, wherein the value is determined based on a Bayesian probability that the value flowing into the sink indicates a privacy threat based on a threshold.

3. The method of claim 2, further comprising:
determining the value as well as additional values associated with additional features; and
determining whether the values as a whole indicate a privacy threat.

4. The method of claim 2, the method further comprising issuing a security warning if a privacy threat exists at the sink.

5. The method of claim 1, wherein determining the value comprises determining a degree of overlap between the feature read at the source statement and the value flowing into the sink.

6. The method of claim 1, wherein determining the value comprises determining characteristics of the sink that are threatening if the data flow was released to the sink.

7. The method of claim 1, wherein determining the value comprises determining a history of data flows to the sink having the same feature.

8. A computing device, comprising:
a storage device;
a processor;
the storage device having instructions that when executed by the processor, cause the computing device to:
identify a data-flow source statement within a computer program;
identify a feature read at the source statement, wherein the feature comprises private data of a private data category;
identify a sink statement of the data flow; and
determine a value associated with the feature flowing into the sink, wherein the value indicates a degree of granularity of the private data flowing into the sink in comparison to the private data identified at the source.

9. The computing device of claim 8, wherein the value is determined based on a Bayesian probability that the value flowing into the sink indicates a privacy threat based on a threshold.

10. The computing device of claim 9, further comprising instructions that when executed by the processor, cause the computing device to:
determine the value as well as additional values associated with additional features; and
determine whether the values as a whole indicate a privacy threat.

11. The computing device of claim 9, further comprising instructions that when executed by the processor, cause the computing device to issue a security warning if a privacy threat exists at the sink.

12. The computing device of claim 8, wherein determining the value comprises determining a degree of overlap between the feature read at the source statement and the value flowing into the sink.

13. The computing device of claim 8, wherein determining the value comprises determining characteristics of the sink that are threatening if the data flow was released to the sink.

14. The computing device of claim 8, wherein determining the value comprises determining a history of data flows to the sink having the same feature.

15. A computer program product for security analysis, the computer product comprising a computer readable storage medium having program code embodied therewith, the program code executable by a processor to perform a method, comprising:
identifying a data-flow source statement within a computer program;
identifying a feature read at the source statement, wherein the feature comprises private data of a private data category;
identifying a sink statement of the data flow;
determining a value associated with the feature flowing into the sink, wherein the value indicates a degree of granularity of the private data flowing into the sink in comparison to the private data identified at the source.

16. The computer program product of claim 15, wherein the value is determined based on a Bayesian probability that the value flowing into the sink indicates a privacy threat based on a threshold.

17. The computer program product of claim 16, the method further comprising:
determining the value as well as additional values associated with additional features; and
determining whether the values as a whole indicate a privacy threat.

18. The computer program product of claim 15, wherein determining the value comprises determining a degree of overlap between the feature read at the source statement and the value flowing into the sink.

19. The computer program product of claim 15, wherein determining the value comprises determining characteristics of the sink that are threatening if the data flow was released to the sink.

20. The computer program product of claim 15, wherein determining the value comprises determining a history of data flows to the sink having the same feature.
